(19) United States
(12) Patent Application Publication
(10) Pub. No.: US 2025/0102655 A1
(43) Pub. Date: Mar. 27, 2025

(54) ANTENNA UNIT

(71) Applicant: PONTOSENSE INC., Waterloo (CA)

(72) Inventors: Lidong CHI, Guangdong (CN); Yunlong LUO, Guangdong (CN); Yang YANG, Guangdong (CN); Alex QI, Waterloo (CA); Yihong QIAN, Guangdong (CN)

(21) Appl. No.: 18/832,238

(22) PCT Filed: Mar. 17, 2022
(86) PCT No.: PCT/CN2022/081339

§ 371 Date: Jul. 23, 2024

(30) Foreign Application Priority Data
Jan. 25, 2022 (CN) 202210087034.3

(51) Int. Cl. G01S 13/02; G01S 7/28

(52) U.S. Cl. CPC G01S 13/0218; G01S 7/2813; G01S 2013/0236

(57) ABSTRACT

An antenna unit in the field of radar antenna technology research is disclosed. The antenna unit includes a PCB dielectric substrate, a metal ground, a feed structure, radiation walls and impedance adjustment structures. The metal ground is on the PCB dielectric substrate. The feed structure, the radiation walls and the impedance adjustment structures are on the metal ground; a plurality of metal via holes of the radiation walls surround the periphery of the feed structure, and a plurality of metal via holes of a radiation wall in an electric polarization direction are connected to each other by a metal sheet. Each impedance adjustment structure is between the feed structure and a radiation wall, and causes a parallel impedance of a radiation resistance and a conduction impedance of the antenna unit to be far less than a coupling impedance between the antenna unit and an external adjacent antenna.

### TECHNICAL FIELD

The invention relates to the technical research field of radar antennas, in particular to an antenna unit for realizing self-suppression of surface waves with high isolation.

### BACKGROUND ART

With the development of communication technology, the distance between antennas and wireless systems (including chips) is unprecedented, and phased array antennas have also been widely used in commercial systems. In this context, as shown in FIG. 1, the surface wave interference of the antenna has become the main factor affecting the performance of the wireless system. The influence of surface wave interference mainly has the following three points: surface wave will reduce the isolation of adjacent antenna elements; Surface waves will deteriorate the pattern performance; Surface waves flowing into the system will reduce the communication throughput of the system. As shown in FIG. 1-FIG. 3, there are two traditional methods to improve the isolation between antenna array elements: physical blocking and active suppression. Physical blocking method is to block the interference of surface waves through certain physical structures (such as metal walls, EBG, etc.). In order to achieve ideal results, this method usually needs a larger size and a longer isolation distance; The active suppression method is to construct the suppression signal, and the amplitude of the suppression signal and the phase of the surface wave signal are the same, which forms a cancellation. The limitations of this method are as follows: 1. Usually, the bandwidth of active suppression is narrow, and it is impossible to form an effective suppression signal in a broadband; 2. For some complex antennas, there are many kinds of surface wave propagation paths, so it is difficult to construct suppression signals.

### SUMMARY OF THE INVENTION

The purpose of the invention is to overcome the problem that the physical blocking method and the active suppression method in the prior art cannot achieve better blocking of surface wave propagation due to their limitations, and to provide an antenna unit with high isolation of surface wave self-suppression.

In order to achieve the above object, the present invention provides the following technical proposal:

An antenna unit comprises a PCB dielectric substrate, a metal ground, a feed structure, a radiation wall and an impedance adjusting structure, wherein the metal ground is arranged on the PCB dielectric substrate, the feed structure, the radiation wall and the impedance adjusting structure are arranged on the metal ground, a plurality of metal vias of the radiation wall surround the feed structure, and the metal vias of the radiation wall in the electric polarization direction are connected with each other through metal sheets; The impedance adjusting structure is located between the feed structure and the radiation wall; A plurality of metal vias of the impedance adjustment structure are connected to each other by grounding radiation metal sheets.

According to the antenna unit of the invention, by designing an impedance adjustment structure inside the antenna, the equivalent impedance of the antenna unit's own conduction impedance and radiation resistance in parallel is much smaller than the coupling impedance between the antenna unit and the external adjacent antenna, and then the surface wave that should have flowed to the outside of the antenna is converted into effective radiation inside the antenna by using the principle that current always tends to flow to the low impedance, thus achieving better effects of surface wave suppression and radiation enhancement, and ensuring the compactness of the antenna. On the other hand, because the surface wave suppression function is realized inside the antenna, there is no need to add additional isolation structures outside the antenna, which is beneficial to saving production and manufacturing costs, keeping the antenna small size and being beneficial to array application.

Preferably, the radiation wall comprises a first opposite side wall and a second opposite side wall, and a plurality of metal vias of the first opposite side wall and a plurality of metal vias of the second opposite side wall surround the feed structure, and a plurality of metal vias of the radiation wall connected with each other through metal sheets in the direction of electric polarization are the second opposite side wall.

Preferably, the impedance adjusting structure is located between the feed structure and the first opposite side wall of the radiation wall.

Preferably, the first opposing side wall and the second opposing side wall form a quadrilateral.

Preferably, the quadrangle is square, rectangle or trapezoid.

Preferably, in the second opposite side wall, the number of metal vias on two opposite sides is equal.

Preferably, in the second opposite side wall, the center distance between adjacent metal vias is 0.45 mm.

Preferably, in the first opposite side wall, the center distance between adjacent metal vias is 0.8 mm.

Preferably, in the impedance adjustment structure, the center distance between adjacent metal vias is 1.1 mm.

Preferably, the diameter of the metal via hole is 0.3 mm.

Compared with the prior art, the invention has the beneficial effects that:
1. The invention provides an antenna unit with high isolation of surface wave self-suppression. By designing an impedance adjustment structure inside the antenna, the equivalent impedance of the antenna unit's own conduction impedance and radiation resistance in parallel is much smaller than the coupling impedance between the antenna unit and the external adjacent antenna, and then the surface wave that should have flowed to the outside of the antenna is converted into effective radiation inside the antenna by using the principle that current always tends to flow to the low impedance, thus achieving better surface wave suppression and radiation enhancement effects and ensuring the compactness of the antenna.
2. Because the surface wave suppression function is realized inside the antenna, the invention does not need to add additional isolation structures outside the antenna, which is beneficial to saving production and manufacturing costs, keeping the antenna small in size and being beneficial to array application.

### BRIEF DESCRIPTION OF THE DRAWINGS

FIG. 1 is a schematic diagram of surface wave interference formed between adjacent antennas.

FIG. 2 is a schematic diagram of the principle of suppressing surface wave interference by physical blocking in the prior art.

FIG. 3 is a schematic diagram of the principle of using active suppression method to suppress surface wave interference in the prior art.

FIG. 4 is a schematic diagram of the principle of suppressing surface wave interference by adjusting equivalent impedance.

FIG. 5 is a schematic structural diagram of the surface wave self-suppression high isolation array antenna element in Embodiment 1.

FIG. 6 is a schematic structural diagram of the surface wave self-suppression high isolation array antenna element in Embodiment 2.

FIG. 7 is the isolation simulation result of the surface wave self-suppression high isolation array antenna element in Embodiment 2.

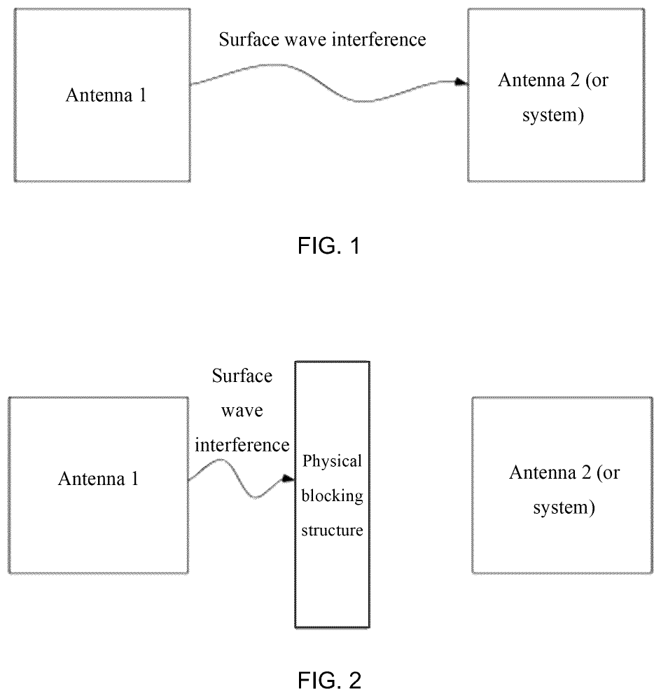

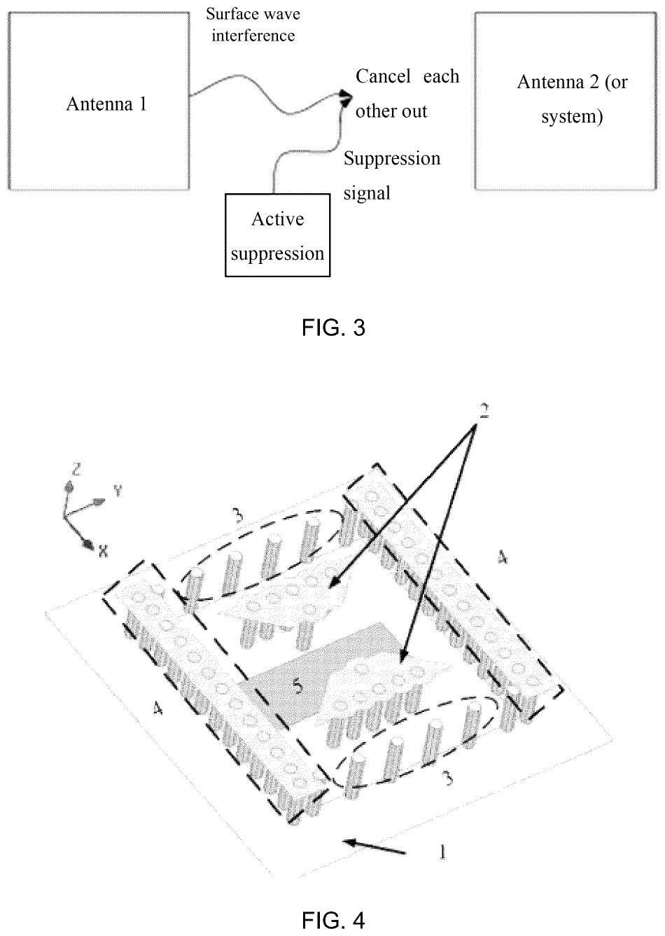

Reference numeral: 1—metal ground, 2—impedance adjusting structure, 3—first opposite side wall, 4—second opposite side wall, 5—feeding structure, and 6—matching structure.

### EMBODIMENTS

In the following, the invention will be further described in detail in combination with experimental examples and specific embodiments. However, it should not be understood that the scope of the above-mentioned subject matter of the present invention is limited to the following embodiments, and all technologies realized based on the contents of the present invention belong to the scope of the present invention.

### Embodiment 1

As shown in FIG. 4, an antenna unit for realizing self-suppression of surface waves with high isolation comprises a PCB dielectric substrate, a metal ground 1, a feeding structure 5 and a radiating wall, wherein the metal ground is arranged on the PCB dielectric substrate, and the feeding structure 5, the radiating wall and the impedance adjusting structure 2 are arranged on the metal ground 1.

A plurality of metal vias of the radiation wall surround the periphery of the feed structure 5, and the metal vias of the radiation wall in the electric polarization direction (X-axis direction in FIG. 4) are connected with each other through metal sheets; The impedance adjusting structure 2 is located between the feed structure 5 and the radiation wall; A plurality of metal vias of the impedance adjustment structure 2 are connected to each other by grounding radiation metal sheets.

Further, the radiating wall comprises a first opposite side wall 3 and a second opposite side wall 4, wherein the first opposite side wall 3 comprises two rows of oppositely arranged metal vias, and the second opposite side wall 4 comprises two rows of oppositely arranged metal vias; the first opposite side wall 3 and the second opposite side wall 4 form a square and surround the feed structure 5; a plurality of metal vias connected with each other by metal sheets in the direction of electric polarization are the second opposite side wall 4; and the radiating wall is in the direction perpendicular to the direction of electric polarization. Metal vias are not connected with each other through other media except through metal ground.

Further, the impedance adjusting structure 2 is located between the feed structure 5 and the first opposite side wall 3 of the radiation wall.

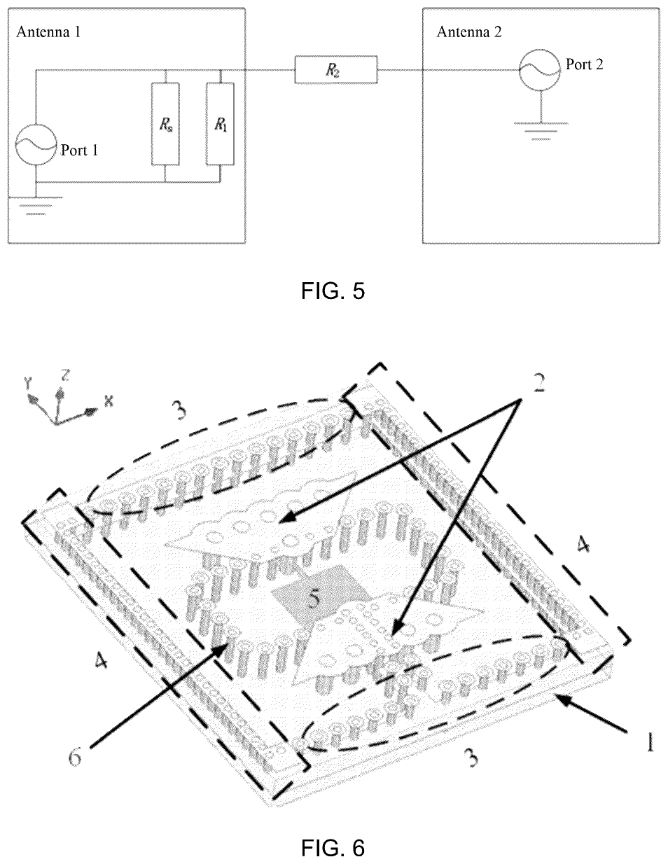

As shown in FIG. 5, the impedance adjustment structure 2 is used to make the parallel impedance of the radiation resistance RS and the conduction impedance R1 of the antenna unit (antenna 1) much smaller than the coupling impedance R2 between the antenna unit and the external adjacent antenna (antenna 2).

The metal via hole can be hollow or solid, which does not affect the isolation effect, and the solid metal via hole can be filled with resin material.

The principle of the invention is that by designing a distributed impedance adjustment structure in the antenna, the equivalent impedance of the antenna unit's own conduction impedance and radiation resistance in parallel is much smaller than the coupling impedance between the antenna unit and the external adjacent antenna, and then the principle that current always tends to flow to the low impedance is used to guide the surface wave energy to flow into the antenna and convert it into effective radiation instead of external coupling, thus achieving better surface wave suppression and radiation enhancement effects and ensuring the compactness of the antenna.

Referring to FIG. 4 again, on the one hand, the current flows from the feed structure 5 to the first opposite side wall 3 of the radiation wall through the metal ground; on the other hand, because the first opposite side wall 3 of the radiation wall is used as the radiator of the antenna, its end is open at work, which is equivalent to infinite impedance, and the impedance adjustment structure 2 is connected to the metal ground between the feed structure 5 and the first opposite side wall 3, and the first opposite side wall 3 and the impedance adjustment structure 2 together form a transmission line with an open end. Therefore, the equivalent resistance of connecting the conduction impedance and radiation resistance of the antenna unit itself in parallel is much smaller than the coupling impedance between the antenna unit and the external adjacent antenna, thus forming an equivalent circuit as shown in FIG. 5, and the coupling impedance R2 between the antenna unit and the external adjacent antenna in FIG. 5 is an infinite open circuit impedance, so the surface wave energy radiates energy from the gap formed by the first opposite side wall 3 and the impedance adjustment structure 2. While reduce that outward propagation across the first opposite side wall 3, converting the surface wave which should flow to the outside of the antenna into effective radiation inside the antenna, achieve better effects of surface wave suppression and radiation enhancement, and maintaining the compactness of the antenna.

Because the surface wave suppression function is realized inside the antenna, no additional isolation structure is needed outside the antenna, which is beneficial to saving production and manufacturing costs.

### Embodiment 2

In this embodiment, the PCB dielectric substrate of the antenna unit is realized by four layers of boards, the dielectric material is Rogers 4350B, and the feed structure 5 adopts striplines.

As shown in FIG. 6, there are two groups of mutually opposite metal vias on the first opposite side wall 3 of the radiation wall, one group has 15 metal vias, and the other group has 14 metal vias, the hole diameter is 0.3 mm, and the hole spacing (the center distance between the two holes) is 0.8 mm.

Two groups of mutually opposite metal vias on the second opposite side wall 4, each group has 33 metal vias, which are arranged in a left bracket “[” shape and a right bracket “]” shape respectively, and the hole diameter is 0.3 mm, and the hole spacing (the center distance between two holes) is 0.45 mm.

The straight lines of the two groups of metal vias in the first opposite side wall 3 and the straight lines of the two groups of metal vias in the second opposite side wall 4 are perpendicular to each other, forming a “ [symbol] ” shape and surrounding the feed structure 5.

There is an impedance adjustment structure 2 between the feed structure 5 and two groups of metal vias of the first opposite sidewall 3, and the impedance adjustment structure 2 comprises a first branch and a second branch. The first branch is located between the feed structure 5 and one group of metal vias of the first metal via array and has 6 metal vias. One end of the 6 metal vias is connected to the metal ground 1, and the other end is connected to each other through a grounding radiation metal sheet. The second branch is located between the feed structure 5 and another group of metal vias in the first opposite side wall 3, and has 4 metal vias, the diameter of which is 0.3 mm, and the hole spacing (the center distance between the two holes) is 0.45 mm. One end of the 4 metal vias is connected to the metal ground 1, and the other end is connected to each other through a grounding radiation metal sheet.

In this embodiment, the matching structure 6 is a plurality of metal vias for impedance matching of the antenna elements.

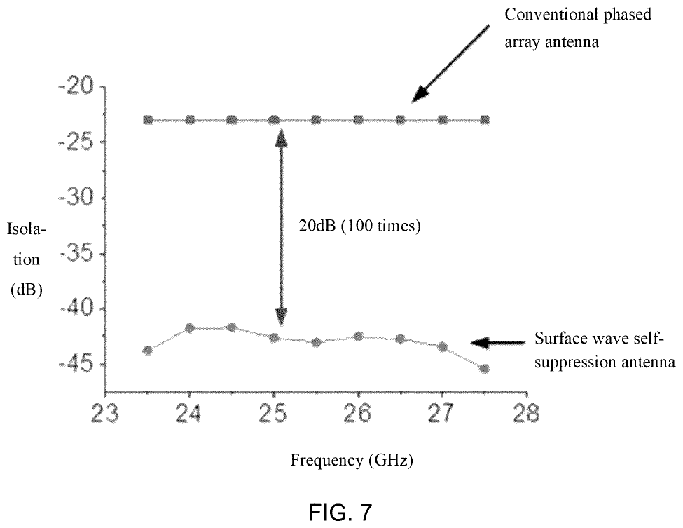

The simulation results of isolation using 2 antenna elements of this embodiment at about one wavelength are shown in FIG. 7. It can be seen that, compared with the conventional phased array antenna at the same array spacing, the antenna element using the surface wave self-suppression of the present invention achieves an isolation level higher than 40 dB, and the isolation is improved by 20 dB (100 times).

The above is only the preferred embodiment of the invention, and it is not used to limit the invention. Any modification, equivalent substitution and improvement made within the spirit and principle of the invention should be included in the protection scope of the invention.

1. An antenna unit, comprising a PCB dielectric substrate, a metal ground (1), a feeding structure (5), a radiating wall and an impedance adjusting structure (2), wherein the metal ground (1) is on the PCB dielectric substrate, and the feeding structure (5), the radiating wall and the impedance adjusting structure (2) are on the metal ground (1); a plurality of metal vias of the radiation wall surround the periphery of the feed structure (5), and the metal vias of the radiation wall in the direction of electric polarization are connected with each other through metal sheets; the impedance adjusting structure (2) is between the feed structure (5) and the radiation wall; a plurality of metal vias of the impedance adjusting structure (2) are connected with each other by grounding radiation metal sheets.

2. An antenna unit according to claim 1, wherein the radiation wall comprises a first opposite side wall (3) and a second opposite side wall (4), a plurality of metal vias of the first opposite side wall (3) and a plurality of metal vias of the second opposite side wall (4) surround the feed structure (5), and a plurality of metal vias of the radiation wall which are connected with each other in the electric polarization direction are the second opposite side wall (4).

3. An antenna unit according to claim 2, wherein the impedance adjustment structure (2) is between the feed structure (5) and the first opposite side wall (3) of the radiation wall.

4. An antenna unit according to claim 3, wherein the first opposite side wall (3) and the second opposite side wall (4) form a quadrilateral.

5. An antenna unit according to claim 4, wherein the quadrilateral is a square, a rectangle or a trapezoid.

6. An antenna unit according to claim 5, wherein the number of metal vias on two opposite sides of the second opposite side wall (4) is equal.

7. An antenna unit according to claim 6, wherein in the second opposite side wall (4), the center distance between adjacent metal vias is 0.45 mm.

8. An antenna unit according to claim 7, wherein the center distance between adjacent metal vias in the first opposite side wall (3) is 0.8 mm.

9. An antenna unit according to claim 8, wherein in the impedance adjustment structure (2), the distance between the centers of adjacent metal vias is 1.1 mm.

10. An antenna unit according to claim 1, wherein the diameter of the metal via hole is 0.3 mm.
